(19) United States
(12) Patent Application Publication
(10) Pub. No.: US 2012/0218346 A1
(43) Pub. Date: Aug. 30, 2012

(54) NOZZLE SURFACE CLEANING DEVICE AND INK-JET RECORDING DEVICE

(76) Inventor: Hiroshi INOUE, Kanagawa (JP)

(21) Appl. No.: 13/402,308

(22) Filed: Feb. 22, 2012

(30) Foreign Application Priority Data
Feb. 24, 2011 (JP) P2011-038910

(51) Int. Cl. B41J 2/165

(52) U.S. Cl. 347/33

(57) ABSTRACT

The dripping of washing liquid and the infiltration of washing liquid from a nozzle surface of a head when the nozzle surface is wiped is suppressed and discharge stability is improved. A wiping unit includes a conveying portion that conveys a wiping web, a washing liquid supplying portion that supplies washing liquid to the wiping web, and a washing liquid collecting portion that collects washing liquid from the wiping web to which washing liquid has been supplied. After washing liquid is supplied to the wiping web, which is conveyed by the conveying portion, at washing liquid supplying portion, surplus washing liquid is collected from the wiping web at the washing liquid collecting portion. The wiping web from which washing liquid has been collected is wound on a pressure roller and comes into press contact with the nozzle surface of the head, thereby wiping web wipes and cleans the nozzle surface.

### BACKGROUND OF THE INVENTION

1. Field of the Invention

The present invention relates to a nozzle surface cleaning device and an ink-jet recording device, and more particularly, to a head cleaning technique that wipes a nozzle surface of an ink-jet head by a wiping member to which washing liquid is supplied.

2. Description of the Related Art

When nozzle surfaces (the surface on which nozzles are formed) of heads are contaminated in an ink-jet recording device, a discharge failure occurs. For this reason, the nozzle surfaces are cleaned regularly.

In the past, a method of cleaning a nozzle surface by wiping the nozzle surface with a blade, a method of cleaning a nozzle surface by wiping the nozzle surface with a web, and the like have been known as a method of cleaning the nozzle surface.

JP2006-239620A discloses a technique that uniformly impregnates washing liquid onto a desired sprayed region by defining a sprayed region, where washing liquid is to be sprayed, on a wiping sheet with a masking means when washing liquid is sprayed on the wiping sheet used to wipe the nozzle surface of a liquid droplet discharge head.

Further, JP2007-7977A discloses a technique that selectively uses a wiping operation with the supply of washing liquid and a wiping operation without the supply of washing liquid by a washing liquid supply means directly or indirectly that supplies washing liquid to the surface of a discharge head and a supply selecting means that selects whether to supply washing liquid by the washing liquid supply means during the surface of a discharge head is wiped.

### SUMMARY OF THE INVENTION

When a head is wiped by a wiping member such as a long web having absorbability, wiping performance varies according to the absorption capacity of the web.

For example, since the absorption performance of the web does not function if the amount of washing liquid contained in the web is large, washing liquid infiltrates into the nozzles when the nozzle surface is wiped. For this reason, the discharge of ink is adversely affected. Further, when the amount of washing liquid exceeding the absorption performance of web the washing liquid of the web is supplied, the dripping of washing liquid from the web occurs while the web is conveyed. As a result, contamination is caused in a device. Furthermore, there also is a demerit that the amount of washing liquid to be used is increased.

Meanwhile, since the absorption capacity of the web is large when the amount of washing liquid contained in the web is small, a large amount of ink is drawn from the nozzles when the nozzle surface is wiped. For this reason, ink stains remain on the nozzle surface in a strip shape.

As described above, it is important to maintain the optimum absorption capacity of the web when washing liquid is supplied to the web.

In contrast, in the technique disclosed in JP2006-239620A, it is possible to uniformly impregnate washing liquid onto the wiping member but a small amount of washing liquid is supplied to the wiping member. For this reason, there is a demerit that time is taken until the washing liquid is uniformly spread on the wiping member so that the wiping member is wet. In addition, since mist floats, there also is a problem in that the inner portion of the device is contaminated.

Moreover, in the technique disclosed in JP2007-7977A, it is not possible to solve the problems of the uniformity of washing liquid in the wiping member or the dripping of washing liquid caused by the excessive amount of washing liquid. Further, when the nozzle surface of the head is wiped without the supply of washing liquid, there also is a problem in that a liquid repellent film of the nozzle surface of the head is scratched.

The invention has been made in consideration of the above-mentioned circumstances, an object of the invention is to provide a nozzle surface cleaning device and an ink-jet recording device that can suppress the dripping of washing liquid and the infiltration of washing liquid into nozzles when wiping a nozzle surface and can improve discharge stability.

In order to achieve the above-mentioned object, according to an aspect of the invention, there is provided a nozzle surface cleaning device that cleans a nozzle surface of an ink-jet head. The nozzle surface cleaning device includes a wiping member travel driving portion that makes a long wiping member, which has absorbability, travel along a predetermined conveying path in a longitudinal direction; a washing liquid supplying portion that supplies washing liquid to the wiping member; a collecting portion that collects surplus washing liquid from the wiping member to which the washing liquid has been supplied, and moistening the wiping member with the amount of washing liquid suitable for wiping the ink-jet head; a pressuring portion that makes the wiping member, from which the surplus washing liquid has been collected, come into press contact with the nozzle surface; and a wiping portion that sequentially wipes the nozzle surface with the wiping member, from which the surplus washing liquid has been collected, by making the wiping member and the ink-jet head move relative to each other so that the wiping member coming into press contact with the nozzle surface slides along the nozzle surface while being made to travel by the wiping member travel driving portion.

According to the aspect of the invention, it is possible to suppress the dripping of washing liquid and the infiltration of washing liquid into nozzles when wiping a nozzle surface and to improve discharge stability.

### BRIEF DESCRIPTION OF THE DRAWINGS

FIG. 1 is a front view showing the structure of a main portion of an ink-jet recording device.

FIG. 2 is a plan view showing the structure of the main portion of the ink-jet recording device.

FIG. 3 is a side view showing the structure of the main portion of the ink-jet recording device.

FIG. 4 is a plan perspective view of a nozzle surface of a head.

FIG. 5 is a view showing the schematic structure of a wiping unit according to a first embodiment.

FIG. 6 is a view showing the schematic structure of a wiping unit according to a second embodiment.

FIG. 7 is a view showing the schematic structure of a wiping unit according to a third embodiment.

FIG. 8 is a view showing the schematic structure of a wiping unit according to another modification.

FIG. 9 is a view showing the schematic structure of a wiping unit according to another modification.

### DESCRIPTION OF THE PREFERRED EMBODIMENTS

Preferred embodiments of the invention will be described below with reference to the accompanying drawings.

### First Embodiment

<Structure of Ink-Jet Recording Device>

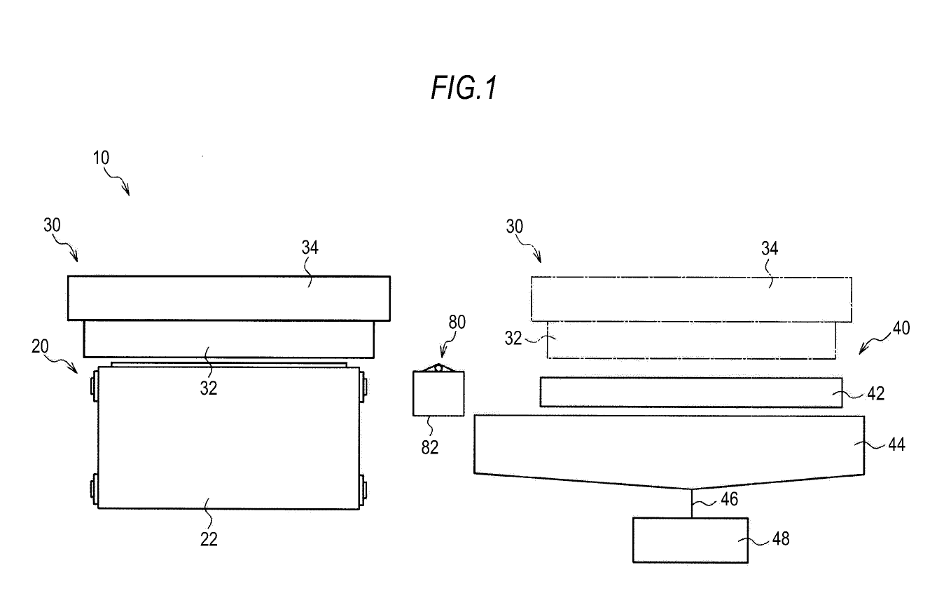

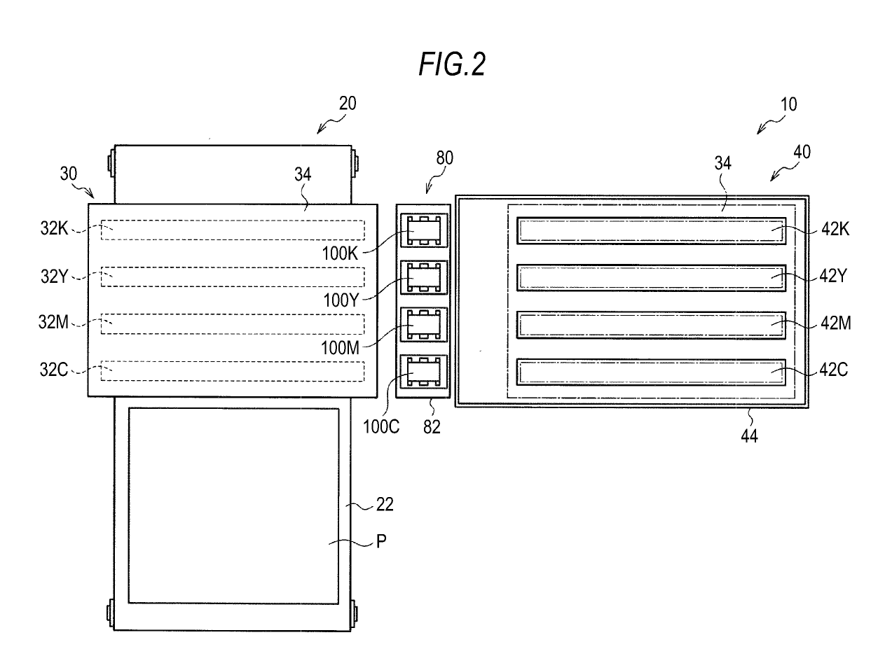

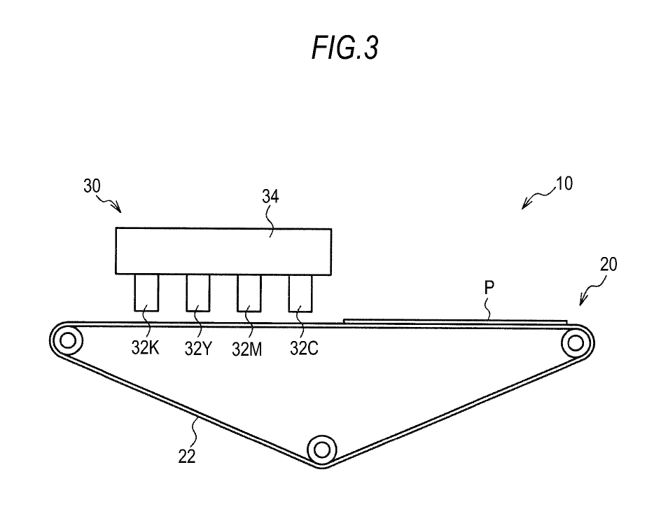

FIGS. 1 to 3 are a front view, a plan view, and a side view showing the structure of a main portion of an ink-jet recording device according to this embodiment.

As shown in FIGS. 1 to 3, an ink-jet recording device 10 is a single-pass type line printer, and mainly includes a sheet conveying mechanism 20, a head unit 30, a maintenance unit 40, and a nozzle surface cleaning device 80. The sheet conveying mechanism 20 conveys a sheet (sheet paper) P that is a recording medium. The head unit 30 discharges droplets of color ink, which correspond to cyan (C), magenta (M), yellow (Y), and black (K), to the sheet P that is conveyed by the sheet conveying mechanism 20. The maintenance unit 40 performs the maintenance of respective heads that are mounted on the head unit 30. The nozzle surface cleaning device 80 cleans the nozzle surfaces of the respective heads mounted on the head unit 30.

The sheet conveying mechanism 20 is formed of a belt conveying mechanism, and makes a sheet P adhere to a traveling belt 22 and horizontally conveys the sheet P.

The head unit 30 mainly includes a head 32C that discharges droplets of cyan ink, a head 32M that discharges droplets of magenta ink, a head 32Y that discharges droplets of yellow ink, a head 32K that discharges droplets of black ink, a head support frame 34 on which the respective heads 32C, 32M, 32Y, and 32K, and a head support frame moving mechanism (not shown) that moves the head support frame 34.

Each of the head (ink-jet head) 32C, 32M, 32Y, and 32K is formed of a line head that corresponds to the maximum width of the sheet P to be printed. Meanwhile, since the respective heads 32C, 32M, 32Y, and 32K have the same structure, the heads 32C, 32M, 32Y, and 32K will be described below as the heads 32 except for a case when the heads are particularly distinguished from each other.

The heads 32 (32C, 32M, 32Y, and 32K) are formed in the shape of a rectangular block, and nozzle surfaces 33 (33C, 33M, 33Y, and 33K) are formed at the bottoms of the heads, respectively.

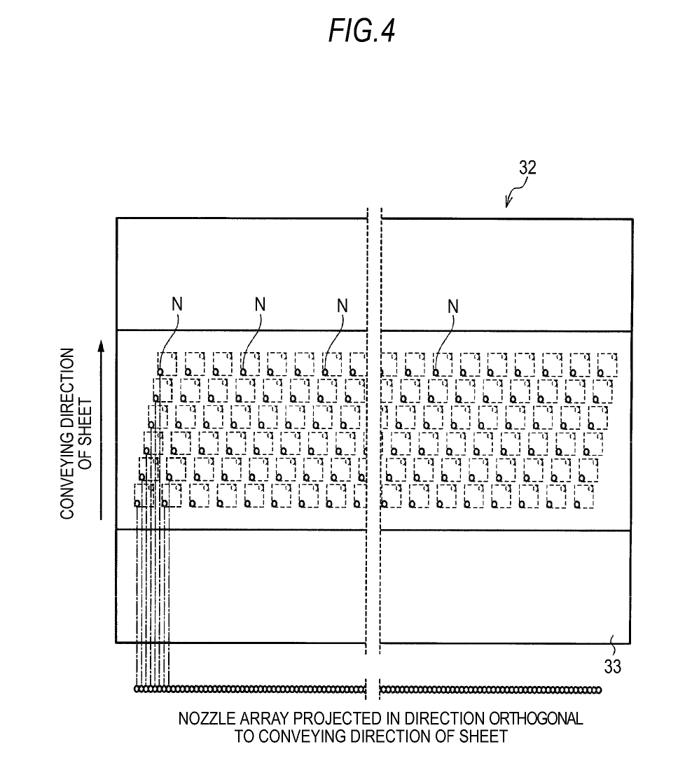

FIG. 4 is a plan perspective view of the nozzle surface of the head.

The nozzle surface 33 is formed in a rectangular shape, and a nozzle array is formed on the nozzle surface in the longitudinal direction of the nozzle surface. The head 32 of this embodiment is formed of a so-called matrix head, and nozzles N are disposed on the head in the form of a two-dimensional matrix. Since it is possible to reduce a substantial interval of the nozzles N, which are projected in the longitudinal direction of the head 32, in the matrix head, it is possible to increase the density of the nozzles N.

Further, the head 32 of this embodiment discharges liquid droplets of ink from the nozzles N by a so-called piezoelectric method. The respective nozzles N communicate with pressure chambers, respectively. The wall surfaces of the pressure chambers are vibrated by piezoelectric elements, so that liquid droplets of ink are discharged from the nozzles N. Meanwhile, a method of discharging ink is not limited thereto, and a thermal method may be used to discharge ink.

The head support frame 34 is provided with a head mounting portion (not shown) on which the respective heads 32 are mounted. The respective heads 32 are detachably mounted on the head mounting portion.

The respective heads 32, which are mounted on the head support frame 34, are disposed orthogonal to a conveying direction of a sheet P. Moreover, the respective heads 32 are disposed at a constant interval in a predetermined order in the conveying direction of a sheet P (in this embodiment, the respective heads 32 are disposed in the order of cyan, magenta, yellow, and black.).

Further, the head mounting portion is provided at the head support frame 34 so as to be freely moved up and down, and is moved up and down by a lifting mechanism (not shown). The respective heads 32, which are mounted on the head mounting portion, are moved up and down by the lifting mechanism so as to be perpendicular to the conveying surface of a sheet P.

The head support frame moving mechanism makes the head support frame 34 horizontally slide in a direction, which is orthogonal to the conveying direction of a sheet P, at a position above the sheet conveying mechanism 20.

The head support frame moving mechanism includes, for example, a ceiling frame that is installed over the sheet conveying mechanism 20, a guide rail that is provided on the ceiling frame, a traveling body that slides on the guide rail, and a driving portion that moves the traveling body along the guide rail (for example, a feed screw mechanism and the like). The head support frame 34 is mounted on the traveling body and horizontally slides.

The head support frame 34 is provided so as to be capable of moving between a predetermined “image recording position” and a “maintenance position” by being driven by the head support frame moving mechanism.

The head support frame 34 is disposed above the sheet conveying mechanism 20 when being positioned at the image recording position. Accordingly, the sheet P, which is conveyed by the sheet conveying mechanism 20, can be printed.

Meanwhile, the head support frame 34 is disposed at an installation position of the maintenance unit 40 when being positioned at the maintenance position.

The maintenance unit 40 is provided with caps 42 (42C, 42M, 42Y, and 42K) that cover the nozzle surfaces 33 of the respective heads 32. When the device is to be stopped for a long time, the heads 32 are moved to the installation position (maintenance position) of the maintenance unit 40 and the nozzle surfaces 33 are covered with the caps 42. Accordingly, the non-discharge of ink, which is caused by drying, is prevented.

Each of the caps 42 is provided with a pressurization-suction mechanism (not shown) that performs pressurization and suction in the nozzle, and a washing liquid supply mechanism (not shown) that supplies washing liquid into the cap 42. Further, a waste liquid tray 44 is disposed below the caps 42. Washing liquid, which is supplied to the cap 42, is discarded in the waste liquid tray 44 and is collected into a waste liquid tank 48 from the waste liquid tray 44 through a waste liquid collecting pipe 46.

The nozzle surface cleaning device 80 is disposed between the sheet conveying mechanism 20 and the maintenance unit 40. When the head support frame 34 is moved to the maintenance position from the image recording position, the nozzle surface cleaning device 80 cleans the nozzle surfaces 33 by wiping the nozzle surfaces 33 of the heads 32 with wiping webs to which washing liquid is supplied.

<Structure of Nozzle Surface Cleaning Device>

The nozzle surface cleaning device 80 mainly includes wiping units 100C, 100M, 100Y, and 100K that are mounted on a wiping device body frame 82, and a wiping device body lifting mechanism (not shown) that moves up and down the wiping device body frame 82.

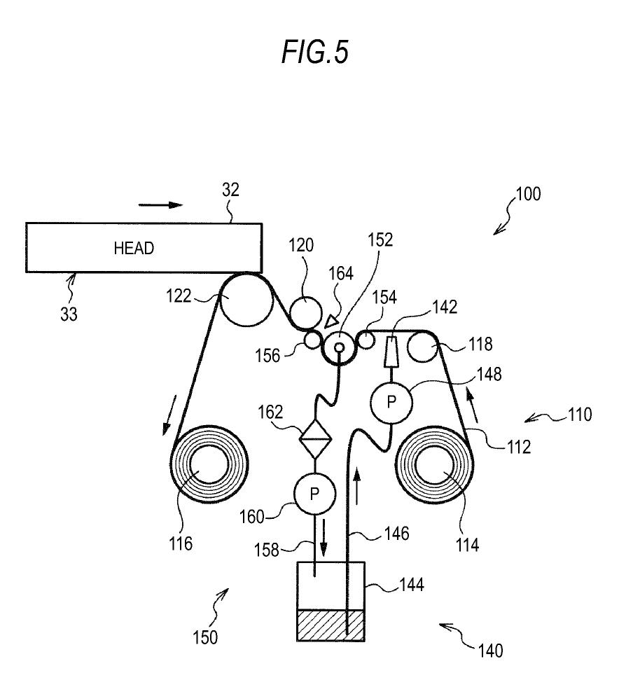

Each of the wiping units 100C, 100M, 100Y, and 100K wipes the nozzle surface 33 by making the wiping web come into contact with the nozzle surface 33 of the head 32 while making the wiping web (112 of FIG. 5), which is formed in the shape of a belt, travel. The wiping units 100C, 100M, 100Y, and 100K are provided at the heads, respectively, and are installed on the wiping device body frame 82 so as to correspond to the installation interval of the heads 32. Meanwhile, since the respective wiping units 100C, 100M, 100Y, and 100K have the same structure, the structure of the wiping units 100C, 100M, 100Y, and 100K will be described here as the structure of the wiping unit 100.

FIG. 5 is a view showing the schematic structure of the wiping unit 100. As shown in FIG. 5, the wiping unit 100 includes a conveying portion 110 (wiping member travel driving portion) that conveys the wiping web 112 (wiping member), a washing liquid supplying portion 140 that supplies washing liquid to the wiping web 112, and a washing liquid collecting portion 150 that collects surplus washing liquid from the wiping web 112 to which the washing liquid has been supplied.

(Structure of Conveying Portion)

The conveying portion 110 includes a feed-side web core 114 that feeds the wiping web 112, which is not yet wiped; a winding-side web core 116 that winds the wiping web 112, which has been wiped, by being rotationally driven by a winding motor (not shown); a first guide roller 118 that is rotated while coming into contact with the wiping web 112 fed from the feed-side web core 114, and guides the wiping web 112 to the washing liquid supplying portion 140; a second guide roller 120 that is rotated while coming into contact with the wiping web 112 fed from the washing liquid supplying portion 140, and guides the wiping web 112 to a pressure roller 122; and a pressure roller 122 (pressure portion) that makes the wiping web 112 come into contact with the nozzle surface 33 of the head 32 at a predetermined pressure. Meanwhile, in this structure, a wiping portion sequentially wipes the nozzle surface 33 with the wiping web 112, from which washing liquid has been collected, by making the wiping web 112 and the head 32 move relative to each other so that the wiping web 112 coming into press contact with the nozzle surface 33 slides along the nozzle surface 33 while being made to travel by the conveying portion 110. The wiping portion includes the feed-side web core 114, the winding motor, the winding-side web core 116, the first guide roller 118, and the second guide roller 120.

The wiping web 112 is formed of a sheet that is knitted or woven and made of ultra-fine fiber, such as polyethylene terephthalate (PET), polyethylene (PE), or nylon (NY) (registered trademark); and is formed in the shape of a belt that has a width corresponding to the width of the nozzle surface 33 of the head 32. The wiping web 112 is wound on the feed-side web core 114 in the shape of a roll, and is provided in a state where the end of the wiping web 112 is fixed to the winding-side web core 116.

The feed-side web core 114 is fitted to and mounted on a feed shaft (not shown) of which one end is fixed and which is horizontally supported. The feed shaft has a double-pipe structure, and an outer cylinder of the feed shaft is supported so as to be rotatable around an inner cylinder of the feed shaft. A reverse rotation preventing mechanism and a friction mechanism are disposed between the inner cylinder and the outer cylinder, and the outer cylinder is adapted to rotate in only one direction (the feed direction of the wiping web 112) with constant resistance.

The winding-side web core 116 is fitted to and mounted on a winding shaft (not shown) that is rotatably and horizontally supported. The winding motor is connected to the winding shaft, and the winding-side web core 116 is driven by the winding motor and rotates in one direction (the winding direction of the wiping web 112).

The winding shaft has a double structure, and an outer cylinder of the winding shaft is supported so as to be rotatable around an inner cylinder of the winding shaft. A torque limiter is disposed between the inner cylinder and the outer cylinder. The outer cylinder is adapted to slide relative to the inner cylinder when a load (torque) equal to or larger than a certain level is applied to the outer cylinder. Accordingly, it is possible to prevent excessive tension from being applied to the wiping web 112.

The first guide roller 118 is rotatably supported by a shaft (not shown) that is horizontally installed, and guides the wiping web 112, which is fed from the feed-side web core 114, toward the washing liquid supplying portion 140.

The second guide roller 120 is rotatably supported by a shaft (not shown) that is horizontally installed, and guides the wiping web 112, which is fed from the washing liquid supplying portion 140, toward the pressure roller 122.

One end of a shaft portion of the pressure roller 122 is rotatably supported, so that the pressure roller 122 is horizontally installed. The pressure roller 122 is formed of a rubber roller corresponding to the width of the wiping web 112, and makes the wiping web 112 come into contact with the nozzle surface 33 of the head 32 at a predetermined pressure.

Meanwhile, since the wiping web 112 is provided in a state where the wiping web 112 is wound on the feed-side web core 114 in the shape of a roll as described above, the wiping web 112 is also mounted (replaced) on the wiping unit 100 in this state. Specifically, after the feed-side web core 114 is fitted to and mounted on the feed shaft, the wiping web 112 is mounted on the first guide roller 118, the second guide roller 120, and the pressure roller 122 in this order and the winding-side web core 116 is fitted to the winding shaft. In this way, the mounting of the wiping web 112 is completed.

(Structure of Washing Liquid Supplying Portion)

The washing liquid supplying portion 140 mainly includes a washing liquid nozzle 142, a washing liquid tank 144 in which washing liquid is stored, a washing liquid pipe 146 that connects the washing liquid tank 144 to the washing liquid nozzle 142, and a washing liquid pump 148 that supplies washing liquid to the washing liquid nozzle 142 from the washing liquid tank 144.

The washing liquid nozzle 142 includes a jetting port that has a width corresponding to the width of the wiping web 112, and jets washing liquid from the jetting port. The washing liquid nozzle 142 is installed so as to jet washing liquid toward the upper side.

When the wiping web 112 passes above the washing liquid nozzle 142, washing liquid jetted from the jetting port is supplied to the wiping web 112. Accordingly, washing liquid is absorbed in the wiping web 112.

The washing liquid nozzle 142 is connected to the washing liquid tank 144 through the washing liquid pipe 146. The washing liquid pump 148 is provided on the washing liquid pipe 146 and supplies the washing liquid, which is stored in the washing liquid tank 144, to the washing liquid nozzle 142.

Meanwhile, here, each of the wiping units 100 has been provided with the washing liquid tank 144 and the washing liquid pump 148. However, one washing liquid tank and one washing liquid pump may be used in common to the respective wiping units 100C, 100M, 100Y, and 100K. In this case, washing liquid, which is supplied by one washing liquid pump, is supplied to washing liquid nozzles 142C, 142M, 142Y, and 142K of the respective wiping units 100C, 100M, 100Y, and 100K; and is jetted from the respective washing liquid nozzles 142.

(Structure of Washing Liquid Collecting Portion)

The washing liquid collecting portion 150 mainly includes a collecting roller 152 that comes into contact with the wiping web 112 to which washing liquid is supplied; third and fourth guide rollers 154 and 156 that guide the wiping web 112 so as to increase the contact area between the collecting roller 152 and the wiping web 112; a washing liquid collecting pipe 158 that connects the collecting roller 152 to the washing liquid tank 144; a collection pump 160 that collects washing liquid by making the wiping web 112, which comes into contact with the collecting roller 152, suck washing liquid and supplies the collected washing liquid to the washing liquid tank 144; a collected liquid filter 162 that removes foreign materials of the washing liquid collected by the collection pump 160; and a moisture meter 164 (measuring portion) that measures the amount of washing liquid contained (absorbed) in the wiping web 112 from which washing liquid has been collected. Meanwhile, the wiping web 112 referred here corresponds to a suction portion.

The wiping web 112 to which the washing liquid has been supplied by the washing liquid supplying portion 140 is guided by the third guide roller 154 and comes into contact with the collecting roller 152.

The collecting roller 152 has plural holes on the surface thereof, and is hollow. For example, a porous roller made of polyolefin, polyurethane, or the like or a metal roller having plural holes is used as the collecting roller 152.

The core of the collecting roller 152 is connected to the washing liquid tank 144 through the washing liquid collecting pipe 158. Further, the collection pump 160 and the collected liquid filter 162 are provided on the washing liquid collecting pipe 158.

The collection pump 160 sucks washing liquid from the wiping web 112 that comes into contact with the collecting roller 152. Surplus washing liquid is collected from the wiping web 112 by the suction of the collection pump 160. The collected washing liquid is supplied to the washing liquid tank 144 through the collected liquid filter 162. In this way, the collecting roller 152 and the collection pump 160 operate as the suction portion that sucks washing liquid from the wiping web 112.

The wiping web 112, from which washing liquid has been collected at the collecting roller 152, is guided to the second guide roller 120 of the conveying portion 110 by the fourth guide roller 156. Here, the moisture meter 164 as the measuring portion that measures the amount of the washing liquid of the wiping web 112 is disposed on the downstream side of the collecting roller 152. The amount of the washing liquid of the wiping web 112 is measured by the moisture meter 164.

(Operation of Nozzle Surface Cleaning Device)

The operation of the nozzle surface cleaning device 80 having the above-mentioned structure will be described below.

The operation of the nozzle surface cleaning device 80 is controlled by a controller (not shown) that controls the entire ink-jet recording device 10. The controller wipes and cleans the nozzle surface 33 by the nozzle surface cleaning device 80 while moving the head 32 to the maintenance position from the image recording position.

The entire nozzle surface cleaning device 80 is adapted to be freely moved up and down by the wiping device body lifting mechanism. The nozzle surface cleaning device 80 is positioned at a predetermined standby position except for when the nozzle surface cleaning device 80 cleans the nozzle surface, and is positioned at a predetermined operating position, that is, a position where the nozzle surface cleaning device 80 is moved up from the standby position by a predetermined distance, when the nozzle surface cleaning device 80 cleans the nozzle surface.

When the nozzle surface cleaning device 80 is positioned at the operating position, it is possible to wipe the nozzle surface 33 of each of the heads 32 by each of the wiping units 100. That is, when the head 32 passes through each of the wiping units 100, the wiping web 112, which is wound on the pressure roller 122, can come into contact with the nozzle surface 33 of the head 32.

The controller controls the conveyance of the wiping web 112, which is performed by the conveying portion 110, at timing when each of the heads 32 reaches the wiping unit 100. That is, the controller starts to drive the winding motor. Accordingly, the wiping web 112 is fed from the feed-side web core 114, travels, and is wound on the winding-side web core 116.

At this time, friction is applied to the feed shaft of the feed-side web core 114 by the friction mechanism and the winding shaft of the winding-side web core 116 slides when a constant load is applied to the winding shaft of the winding-side web core 116 by a torque limiter. Accordingly, it is possible to apply constant tension to the wiping web 112 and to make the wiping web 112 travel.

Further, the controller moistens the wiping web 112 with washing liquid by making the wiping web 112 travel and controlling the washing liquid supplying portion 140 at the same time.

The washing liquid nozzle 142 jets the washing liquid, which is supplied from the washing liquid tank 144 by the washing liquid pump 148, toward the upper side. When the wiping web 112 passes above the washing liquid nozzle 142, the jetted washing liquid is supplied to the wiping web 112. Accordingly, washing liquid is absorbed in the wiping web 112. At this time, a predetermined amount of washing liquid more than the amount of washing liquid, which is suitable for wiping and cleaning the nozzle surface 33, is supplied to the wiping web 112. For example, the amount of washing liquid, which saturates the absorption capacity of the wiping web 112, is supplied to the wiping web 112.

Moreover, the controller collects washing liquid from the wiping web 112, to which washing liquid has been supplied, by making the wiping web 112 travel and controlling the washing liquid collecting portion 150 at the same time.

The wiping web 112 to which washing liquid has been supplied is made to come into contact with the collecting roller 152 by the third and fourth guide rollers 154 and 156.

When the collection pump 160 is driven, negative pressure is generated in the collecting roller 152 by the suction force of the collection pump 160. Accordingly, washing liquid absorbed in the wiping web 112 is sucked from the wiping web 112, which comes into contact with the collecting roller 152, through the holes of the collecting roller 152. Therefore, surplus washing liquid is collected from the wiping web 112, so that the wiping web 112 is moistened with an appropriate amount of washing liquid (the amount of washing liquid suitable for wiping the nozzle surface 33).

Since the wiping web 112 is moistened with an appropriate amount of washing liquid by the collection of surplus washing liquid as described above, the absorption capacity of the wiping web 112 is in an optimum state. As a result, it is possible to suppress the dripping of washing liquid and the infiltration of washing liquid into the nozzles N when the nozzle surface 33 is wiped.

Meanwhile, the optimum state of the absorption capacity of the wiping web 112 varies according to the material or thickness of the wiping web 112, the diameter of the nozzle, the composition of ink, or the like. Further, an appropriate amount of washing liquid varies in accordance with the ink-jet heads 32C, 32M, 32Y, and 32K. Therefore, the amount of washing liquid collected from the collecting roller 152 is appropriately set.

The collected washing liquid is guided to the washing liquid collecting pipe 158 and passes through the collected liquid filter 162, which is provided on the path, so that impurities such as dirt are removed. After that, the collected washing liquid is supplied to the washing liquid tank 144, and is reuse.

The amount of washing liquid of the wiping web 112, from which washing liquid is collected by the collecting roller 152, is measured by the moisture meter 164. It is possible to adjust the amount of washing liquid to be collected from the collecting roller 152 and to control the amount of washing liquid of the wiping web 112, from which washing liquid has been collected, to an appropriate amount by controlling the collection pump 160 according to the measured amount of washing liquid.

That is, when the amount of washing liquid, which is measured by the moisture meter 164, is larger than an appropriate amount, the collection pump 160 is controlled so that the suction force of the collection pump 160 is increased. In contrast, when the amount of washing liquid, which is measured by the moisture meter 164, is smaller than an appropriate amount, the collection pump 160 is controlled so that the suction force of the collection pump 160 is reduced. It is possible to more accurately control the absorption capacity of the wiping web 112 by performing feedback control as described above.

The wiping web 112 to which washing liquid has been supplied as described above travels by the drive of the winding motor and comes into press contact with the nozzle surface 33 at the pressure roller 122, so that the nozzle surface 33 is wiped and washed.

At this time, the wiping web 112 wipes the nozzle surface 33 by traveling in the direction opposite to the moving direction of the nozzle surface 33. Accordingly, it is possible to efficiently wipe the nozzle surface 33. Further, it is possible to always wipe the nozzle surface 33 by new surface (unused portion) of the wiping web 112.

The wiping web 112, which has wiped the nozzle surface 33, is wound on the winding-side web core 116. Further, the head 32 is moved to the maintenance position and the nozzle surface 33 is covered with the cap 42.

When the amount of washing liquid contained in the wiping web 112 is large as described above, washing liquid infiltrates into the nozzles when the nozzle surface is wiped. In contrast, when the amount of washing liquid contained in the wiping web 112 is small, a large amount of ink is drawn from the nozzles when the nozzle surface is wiped. In this embodiment, it is possible to solve these problems by collecting surplus washing liquid from the wiping web 112 with the collecting roller 152 and the collection pump 160 and maintaining the wiping web 112 at an optimum absorption capacity.

Here, the nozzle surface 33 has been wiped and cleaned one time. However, the number of times of wiping may be controlled according to the degree of contamination of the nozzle surface 33. The degree of contamination of the nozzle surface 33 is conjectured from the time elapsed from the previous cleaning of the nozzle surface, the number of times of the discharge of the head 32, the number of printed sheets, or the like.

When the time elapsed from the previous cleaning of the nozzle surface is longer than a predetermined time or the number of times of the discharge of the nozzle of the head 32 or the number of printed sheets is larger than a predetermined number, it is determined that the degree of contamination of the nozzle surface 33 is high and wiping is performed several times.

In the case where wiping is performed several times, finishing wiping for adjusting the meniscus of the nozzle surface 33 is finally performed after wiping for removing contamination is performed. For example, in the case where wiping is performed three times, wiping for removing contamination is performed at the first and second times and finishing wiping is performed at the third time.

Wiping for removing contamination is wiping that reduces the amount of collected washing liquid by performing a control to reduce the suction force of the collection pump 160. For example, the amount of washing liquid contained in the wiping web 112 is made larger than an appropriate amount. It is possible to appropriately remove contamination by increasing the amount of washing liquid contained in the wiping web 112 even though the degree of contamination of the nozzle surface 33 is high.

Further, in the case of the finishing wiping, the amount of collected washing liquid is slightly increased by performing a control to increase the suction force of the collection pump 160, so that the amount of washing liquid contained in the wiping web 112 is made smaller than an appropriate amount. It is possible to utilize the absorption capacity of the wiping web 112 by reducing the amount of washing liquid contained in the wiping web 112. As a result, it is possible to absorb washing liquid, which enters the nozzles, by the wiping web 112.

Meanwhile, when wiping is performed several times, it may be possible to gradually reduce the amount of washing liquid, which is contained in the wiping web 112, by increasing the amount of collected washing liquid in stages whenever wiping is performed.

Moreover, when it is determined that the degree of contamination of the nozzle surface 33 is high from the determination of contamination of the nozzle surface 33, wiping is performed with a small amount of collected washing liquid. Although not shown, the amount of collected washing liquid may be made large when a determination unit (determination portion) determines that the degree of contamination of the nozzle surface is low.

It is possible to appropriately wipe and clean the nozzle surface according to the contamination of the nozzle surface 33 by controlling the amount of washing liquid contained in the wiping web 112 as described above.

### Second Embodiment

Next, a second embodiment of the invention will be described. Meanwhile, the description of the same structure as the structure of the first embodiment will be omitted in the following description. In the first embodiment, surplus washing liquid of the wiping web has been collected by the suction of the collection pump. However, in the second embodiment, surplus washing liquid of a wiping web is collected by the compression of a compression portion.

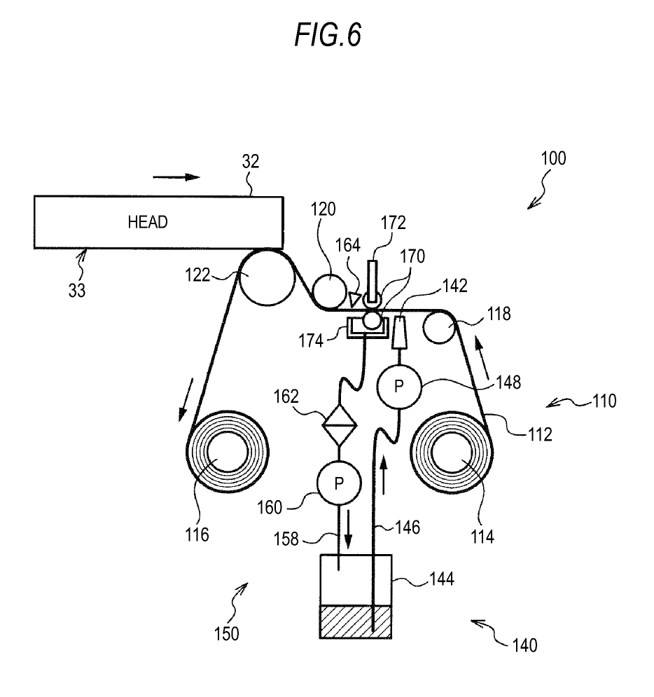

FIG. 6 is a view showing the schematic structure of a wiping unit 100 according to this embodiment. As shown in FIG. 6, a washing liquid collecting portion 150 of the wiping unit 100 includes a pair of squeeze rollers 170, a pressure adjusting mechanism 172, and a collecting-receiving member 174, instead of the collecting roller 152, the third guide roller 154, and the fourth guide roller 156 of the washing liquid collecting portion 150 of the first embodiment.

The pair of squeeze rollers 170 is a compression portion that includes two rollers facing each other. Each of the squeeze rollers has a width corresponding to the width of the wiping web 112, and is made of rubber, such as silicon or ethylene propylene rubber (EPDM), which is not suffered from washing liquid, or metal such as stainless steel (SUS).

The pair of squeeze rollers 170 is disposed on the downstream side of a washing liquid nozzle 142 on a conveying path of the wiping web 112. The pair of squeeze rollers 170 squeezes out washing liquid from the wiping web 112 by making the wiping web 112, to which washing liquid is supplied, be interposed therebetween and pressing the wiping web 112 (meanwhile, the wiping web 112 described here corresponds to a compression portion). Accordingly, surplus washing liquid is collected from the wiping web 112, and the wiping web 112 is moistened with an appropriate amount of washing liquid.

The pressure adjusting mechanism 172 adjusts the pressure of the squeeze rollers by the displacement of a cam (not shown). Accordingly, it is possible to increase the amount of washing liquid, which is to be collected from the wiping web 112, by increasing pressure, and to reduce the amount of washing liquid, which is to be collected, by reducing pressure.

Therefore, it is possible to control the amount of washing liquid of the wiping web 112, from which washing liquid has been collected, to an appropriate amount by controlling the pressure adjusting mechanism 172 according to the amount of washing liquid that is measured by a moisture meter 164. Further, when wiping is performed several times, it may be possible to perform finishing wiping and wiping for removing the above-mentioned contamination by controlling the pressure adjusting mechanism 172.

Furthermore, a collecting-receiving member 174, which collects the squeezed washing liquid, is provided below the pair of squeeze rollers 170.

The washing liquid, which is collected in the collecting-receiving member 174, is sucked by a collection pump 160 and is guided to the washing liquid collecting pipe 158. After impurities are removed from the washing liquid at a collected liquid filter 162, the washing liquid is supplied to the washing liquid tank 144 and reused.

The wiping web 112, which is moistened with an appropriate amount of washing liquid as described above, comes into contact with the nozzle surface 33 at a pressure roller 122, and sequentially wipes the nozzle surface 33 by an unused portion thereof.

### Third Embodiment

Next, a third embodiment of the invention will be described. Meanwhile, the description of the same structure as the structure of the above-mentioned embodiment will be omitted in the following description. In this embodiment, surplus washing liquid is collected by being vaporized by an air blowing portion and a heating portion.

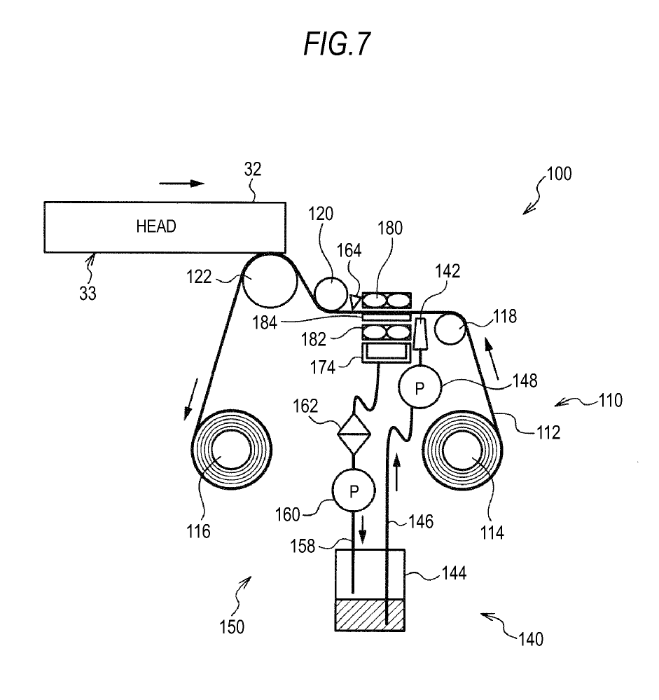

FIG. 7 is a view showing the schematic structure of a wiping unit 100 according to this embodiment. As shown in FIG. 7, a washing liquid collecting portion 150 of the wiping unit 100 includes an air blowing fan 180 (air blowing portion), a suction fan 182, and a heating plate 184 (heating portion).

The air blowing fan 180 is an air blowing portion that vaporizes washing liquid that is supplied to the wiping web 112. The air blowing fan 180 has a width corresponding to the width of the wiping web 112, is disposed above the wiping web 112, and is adapted to be capable of blowing air downward. The air blowing fan 180 facilitates the evaporation of washing liquid, which is supplied to the wiping web 112, by supplying dried air to the wiping web 112.

The suction fan 182 has a width corresponding to the width of the wiping web 112, and is disposed below the heating plate 184. The suction fan 182 is adapted to be capable of sucking air downward from above, and sucks washing liquid, which is vaporized from the wiping web 112, downward.

Likewise, the heating plate 184 has a width corresponding to the width of the wiping web 112, and is disposed between the wiping web 112 and the suction fan 182. A tapered heater (not shown) is disposed on the back of the heating plate 184. This heater is a heating portion that vaporizes washing liquid that is supplied to the wiping web 112, and the heating plate 184 is heated up to about 60° C. by this heater. Further, since the heating plate 184 is provided with plural holes, the wiping web 112 adheres to the heating plate 184 when the suction fan 182 sucks air from above.

Accordingly, the heat of the heater is transferred to the wiping web 112 that is made to adhere to the heating plate 184 by the suction fan 182, and surplus washing liquid of the wiping web 112 is vaporized by this heat. Therefore, the wiping web 112 is moistened with an appropriate amount of washing liquid.

Moreover, washing liquid contained in the wiping web 112 is heated, so that the chemical change of the washing liquid is activated. Accordingly, it is possible to expect the improvement of the removal performance of contamination when the nozzle surface 33 is wiped.

Meanwhile, it is possible to adjust the amount of washing liquid, which is vaporized from the wiping web 112, by the amount of air blown by the air blowing fan 180 and the heating temperature of the heating plate 184. That is, it is possible to increase the amount of washing liquid, which is to be collected from the wiping web 112, by increasing the amount of air blown by the air blowing fan 180 and to reduce the amount of washing liquid, which is to be collected, by reducing the amount of blown air. Further, it is possible to increase the amount of washing liquid, which is to be collected from the wiping web 112, by raising the heating temperature of the heating plate 184 and to reduce the amount of washing liquid, which is to be collected, by lowering the heating temperature. Meanwhile, it is necessary to note that the heating temperature of the heating plate 184 is adjusted in the range where the chemical function of washing liquid does not deteriorate by the decomposition of the washing liquid.

Accordingly, it is possible to control the amount of washing liquid of the wiping web 112, from which washing liquid has been collected, to an appropriate amount by controlling the amount of air blown by the air blowing fan 180 and the heating temperature of the heating plate 184 according to the amount of washing liquid measured by the moisture meter 164. Further, when wiping is performed several times, finishing wiping and wiping for removing the above-mentioned contamination may be performed.

Furthermore, a collecting-receiving member 174, which liquefies and receives washing liquid vaporized from the wiping web 112, is provided below the suction fan 182.

The washing liquid, which is received in the collecting-receiving member 174, is sucked by the collection pump 160 and is guided to the washing liquid collecting pipe 158. After impurities are removed from the washing liquid at a collected liquid filter 162, the washing liquid is supplied to the washing liquid tank 144 and reused.

The wiping web 112, which is moistened with an appropriate amount of washing liquid as described above, comes into contact with the nozzle surface 33 at a pressure roller 122, and sequentially wipes the nozzle surface 33 by an unused surface thereof.

Meanwhile, here, surplus washing liquid of the wiping web 112 has been vaporized by air-blowing and heating. However, only any one of air-blowing and heating may be used to vaporize surplus washing liquid of the wiping web.

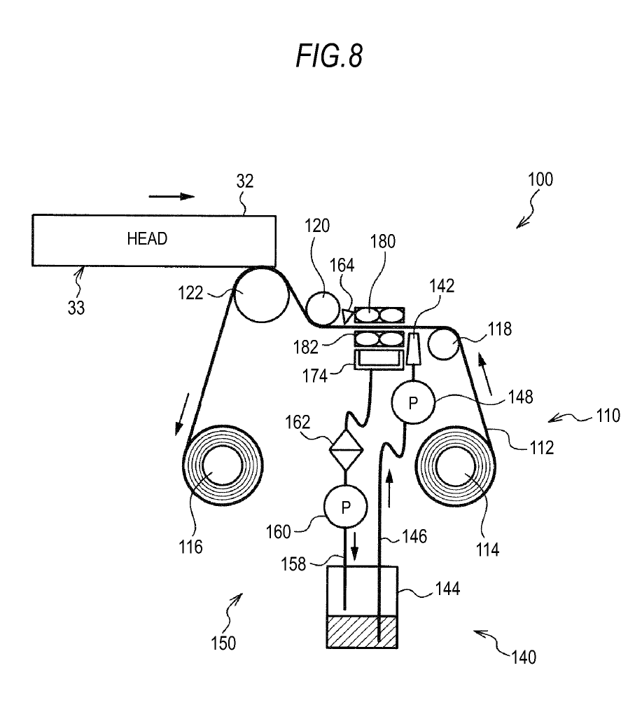

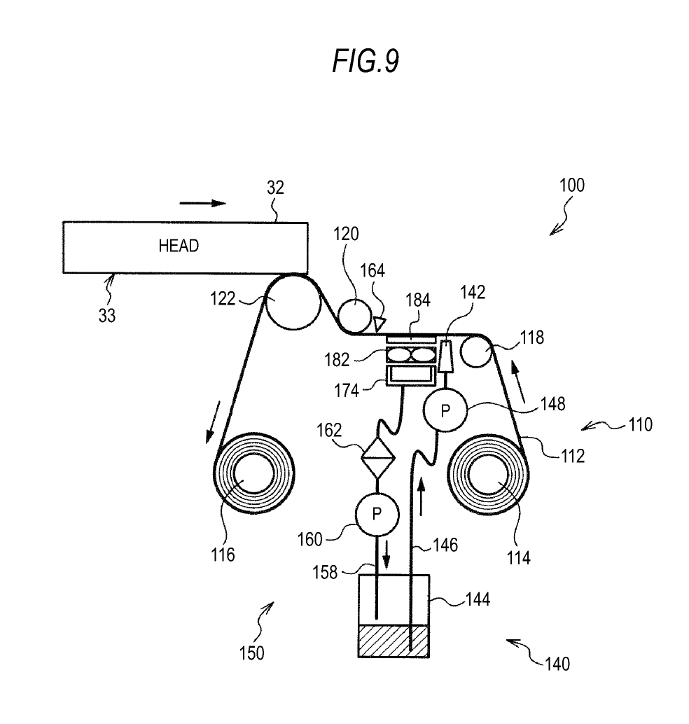

For example, there is considered a structure where surplus washing liquid of the wiping web is vaporized using the air blowing fan 180 without using the heating plate 184 as shown in FIG. 8 or a structure where surplus washing liquid of the wiping web is vaporized using the heating plate 184 without using air blowing fan 180 as shown in FIG. 9.

As described above, according to the invention, it is possible to wipe the nozzle surface of the head while maintaining the absorption capacity of the wiping web in an optimum state, by collecting surplus washing liquid contained in the wiping web after supplying washing liquid to the wiping web. Accordingly, since it is possible to suppress the dripping of washing liquid and the infiltration of washing liquid from the nozzles when the nozzle surface is wiped, the discharge stability of the nozzles is improved and it is possible to prevent contamination in the device.

Further, if a collection path along which the collected washing liquid is reused is provided, it is possible to effectively utilize washing liquid without making washing liquid be wasted. Furthermore, it is possible to make the improvement of wiping performance and the amount of used washing liquid be compatible by changing the amount of washing liquid, which is to be collected, according to the degree of contamination of the nozzle surface or the frequency of wiping.

In the above-mentioned embodiments, the method of jetting washing liquid toward the wiping web 112 from the washing liquid nozzles 142 has been employed as a method of supplying washing liquid to the wiping web 112. However, a method of supplying washing liquid to the wiping web 112 is not limited thereto. For example, a method of immersing the wiping web 112 in washing liquid, a method of making the wiping web 112 come into contact with washing liquid flowing on a predetermined surface, a method of making washing liquid overflow from nozzles and making the washing liquid come into contact with the wiping web 112, and the like may be employed.

Further, in the above-mentioned embodiments, the nozzle surface 33 has been wiped and cleaned while the head 32 is moved to the maintenance position from the image recording position. However, the nozzle surface 33 may be wiped and cleaned while the head 32 is moved to the image recording position from the maintenance position.

Furthermore, in the above-mentioned embodiments, the wiping web 112 has had a width corresponding to the width of the nozzle surface 33 of the head 32 in a transverse direction of the nozzle surface and the nozzle surface 33 has been wiped. However, a direction where the nozzle surface is wiped is not limited to this direction. That is, the nozzle surface may be wiped with a wiping web that has a width corresponding to the width of the nozzle surface in the longitudinal direction of the nozzle surface.

Moreover, the above-mentioned embodiments may be appropriately combined with each other.

<Additional Remark>

As understood from the embodiments described in detail above, this specification includes the disclosure of various technological ideas including the following inventions.

(Invention 1): A nozzle surface cleaning device that cleans a nozzle surface of an ink-jet head, the nozzle surface cleaning device including: a wiping member travel driving portion that makes a long wiping member, which has absorbability, travel along a predetermined conveying path in a longitudinal direction; a washing liquid supplying portion that supplies washing liquid to the wiping member; a collecting portion that collects surplus washing liquid from the wiping member to which the washing liquid has been supplied, and moistening the wiping member with the amount of washing liquid suitable for wiping the ink-jet head; a pressuring portion that makes the wiping member, from which the washing liquid has been collected, come into press contact with the nozzle surface; and a wiping portion that sequentially wipes the nozzle surface with the wiping member, from which washing liquid has been collected, by making the wiping member and the ink-jet head move relative to each other so that the wiping member coming into press contact with the nozzle surface slides along the nozzle surface while being made to travel by the wiping member travel driving portion.

According to Invention 1, surplus washing liquid is collected after washing liquid is supplied to the wiping member having absorbability, and the nozzle surface is sequentially wiped by an unused portion of the wiping member from which washing liquid has been collected. Accordingly, it is possible to suppress the dripping of washing liquid and the infiltration of washing liquid from nozzles when the nozzle surface is wiped, and to improve discharge stability.

(Invention 2): In the nozzle surface cleaning device of Invention 1, the collecting portion includes a suction portion that sucks washing liquid from the wiping member to which washing liquid has been supplied.

Accordingly, it is possible to appropriately collect surplus washing liquid. Meanwhile, a roller that has plural holes on the surface thereof, is hollow, comes into contact with the wiping member, and can be rotated in the conveying direction; and a suck pump that is connected to a hollow portion of the roller and sucks from the hollow portion may be used as the suction portion.

(Invention 3): In the nozzle surface cleaning device of Invention 1 or 2, the collecting portion includes a compression portion that squeezes out washing liquid from the wiping member to which washing liquid has been supplied.

Accordingly, it is possible to appropriately collect surplus washing liquid. Meanwhile, a pair of squeeze rollers, which makes the wiping member be interposed therebetween and pressing the wiping member, may be used as the compression portion.

(Invention 4): In the nozzle surface cleaning device of any one of Inventions 1 to 3, the collecting portion includes an air blowing portion that vaporizes washing liquid by blowing air to the wiping member to which washing liquid has been supplied.

Accordingly, it is possible to appropriately collect surplus washing liquid. Meanwhile, an air blowing fan may be used as the air blowing portion.

(Invention 5): In the nozzle surface cleaning device of any one of Inventions 1 to 4, the collecting portion includes a heating portion that vaporizes washing liquid by heating the wiping member to which washing liquid has been supplied.

Accordingly, it is possible to appropriately collect surplus washing liquid. Meanwhile, a heating plate that comes into contact with the wiping member and a heater that heats the heating plate may be used as the heating portion.

(Invention 6): In the nozzle surface cleaning device of any one of Inventions 1 to 5, the washing liquid supplying portion reuses washing liquid that is collected by the collecting portion.

Since washing liquid is reuse, it is possible to effectively utilize washing liquid without making washing liquid be wasted.

(Invention 7): The nozzle surface cleaning device of any one of Inventions 1 to 6 further includes a measuring portion that measures the amount of washing liquid contained in the wiping member from which washing liquid has been collected, and the collecting portion collects washing liquid from the wiping member to which washing liquid has been supplied so that the measured amount of washing liquid become constant.

It is possible to always maintain the wiping member at an optimum absorption capacity by controlling the amount of washing liquid, which is to be collected, on the basis of measurement results.

(Invention 8): In the nozzle surface cleaning device of any one of Inventions 1 to 7, the wiping portion wipes the nozzle surface several times by making the wiping member and the ink-jet head move relative to each other several times, and the collecting portion makes the amount of washing liquid, which is to be collected at the final wiping of the several times of wiping, larger than the amount of washing liquid that is to be collected at the previous wiping.

It is possible to appropriately remove contamination by controlling the amount of washing liquid, which is to be collected, in this way even though the degree of contamination of the nozzle surface is high.

(Invention 9): The nozzle surface cleaning device of any one of Inventions 1 to 8 further includes a determination portion that determines the degree of contamination of the nozzle surface, and the collecting portion makes the amount of washing liquid to be collected be smaller than a predetermined amount when the determination portion determines that the degree of contamination is high, and makes the amount of washing liquid to be collected be larger than a predetermined amount when the determination portion determines that the degree of contamination is low.

Accordingly, it is possible to wipe and clean the nozzle surface with the amount of washing liquid corresponding to the degree of contamination of the nozzle surface.

(Invention 10): An ink-jet recording device including: a conveying portion that conveys a medium; an ink-jet head that records an image on the medium conveyed by the conveying portion by discharging ink droplets to the medium; and the nozzle surface cleaning device according to any one of Inventions 1 to 9 that cleans a nozzle surface of the ink-jet head.

When the nozzle surface cleaning device is included, it is possible to provide an ink-jet recording device of which discharge stability is increased.

(Invention 11): In the ink-jet recording device of Invention 10, plural ink-jet heads are disposed on a conveying path of the medium, and each of the ink-jet heads is provided with the nozzle surface cleaning device.

Since each of the ink-jet heads is provided with the nozzle surface cleaning device, it is possible to appropriately wipe each of the ink-jet heads.

What is claimed is:

1. A nozzle surface cleaning device that cleans a nozzle surface of an ink-jet head, the nozzle surface cleaning device comprising:
a wiping member travel driving portion that makes a long wiping member, which has absorbability, travel along a predetermined conveying path in a longitudinal direction;
a washing liquid supplying portion that supplies washing liquid to the wiping member;
a collecting portion that collects surplus washing liquid from the wiping member to which the washing liquid has been supplied, and moistening the wiping member with the amount of washing liquid suitable for wiping the ink-jet head;
a pressuring portion that makes the wiping member, from which the surplus washing liquid has been collected, come into press contact with the nozzle surface; and
a wiping portion that sequentially wipes the nozzle surface with the wiping member, from which the surplus washing liquid has been collected, by making the wiping member and the ink-jet head move relative to each other so that the wiping member coming into press contact with the nozzle surface slides along the nozzle surface while being made to travel by the wiping member travel driving portion.

2. The nozzle surface cleaning device according to claim 1,
wherein the collecting portion includes a suction portion that sucks the surplus washing liquid from the wiping member to which washing liquid has been supplied.

3. The nozzle surface cleaning device according to claim 1,
wherein the collecting portion includes a compression portion that squeezes out the surplus washing liquid from the wiping member to which washing liquid has been supplied.

4. The nozzle surface cleaning device according to claim 1,
wherein the collecting portion includes an air blowing portion that vaporizes the surplus washing liquid by blowing air to the wiping member to which the washing liquid has been supplied.

5. The nozzle surface cleaning device according to claim 1,
wherein the collecting portion includes a heating portion that vaporizes the surplus washing liquid by heating the wiping member to which the washing liquid has been supplied.

6. The nozzle surface cleaning device according to claim 1,
wherein the washing liquid supplying portion reuses the surplus washing liquid that is collected by the collecting portion.

7. The nozzle surface cleaning device according to claim 1, further comprising:
a measuring portion that measures the amount of washing liquid contained in the wiping member from which the washing liquid has been collected,
wherein the collecting portion collects the surplus washing liquid from the wiping member to which the washing liquid has been supplied so that the measured amount of the washing liquid become constant.

8. The nozzle surface cleaning device according to claim 1,
wherein the wiping portion wipes the nozzle surface several times by making the wiping member and the ink-jet head move relative to each other several times, and
the collecting portion makes the amount of washing liquid, which is to be collected at the final wiping of the several times of wiping, larger than the amount of washing liquid that is to be collected at the previous wiping.

9. The nozzle surface cleaning device according to claim 1, further comprising:
a determination portion that determines a degree of contamination of the nozzle surface,
wherein the collecting portion makes the amount of washing liquid to be collected be smaller than a predetermined amount when the determination portion determines that the degree of contamination is high, and makes the amount of washing liquid to be collected be larger than a predetermined amount when the determination portion determines that the degree of contamination is low.

10. An ink-jet recording device comprising:
a conveying portion that conveys a medium;
an ink-jet head that records an image on the medium conveyed by the conveying portion by discharging ink droplets to the medium; and
the nozzle surface cleaning device according to claim 1 that cleans a nozzle surface of the ink-jet head.

11. The ink-jet recording device according to claim 10,
wherein a plurality of ink-jet heads are disposed on a conveying path of the medium, and each of the ink-jet heads is provided with the nozzle surface cleaning device.
